(19) United States
(12) Patent Application Publication
(10) Pub. No.: US 2004/0107403 A1
(43) Pub. Date: Jun. 3, 2004

(54) Presenting HTML content on a small screen terminal display

(76) Inventor: Jon Stephensen von Tetzchner, Oslo (NO)

Correspondence Address: Finnegan, Henderson, Farabow,, Garrett & Dunner, L.L.P., 1300 I Street, N.W., Washington, DC, 20005-3315, US

(21) Appl. No.: 10/654,455

(22) Filed: Sep. 4, 2003

Related U.S. Application Data
(60) Provisional application No. 60/410,267, filed on Sep. 13, 2002.

(30) Foreign Application Priority Data
Sep. 5, 2002 (NO) 2002 4243

(51) Int. Cl. G06F 15/00

(52) U.S. Cl. 715/513

(57) ABSTRACT

The invention relates to a method for presenting a HTML document on a display on a mobile client terminal. The method comprises the steps of reformatting the HTML document by enforcing at least one client-side style sheet, thus adapting the width of the reformatted document to the width of the display, and presenting the reformatted document on the display. In particular, the step of reformatting the HTML document includes converting table cells in the HTML document to block-level elements. Image blocking/reduction and transformation of space characters is advantageously also employed in the reformatting step. The invention also relates to a mobile terminal and a computer program for performing the method.

### TECHNICAL FIELD

The invention relates generally to the technical field of graphical user interfaces. More particularly, the invention relates to a method, a device and a computer program for presenting a HTML document, which was designed for presentation on a large desktop monitor, on a small-sized display on a client terminal such as a mobile telephone, a PDA or a palmtop computer.

### BACKGROUND OF THE INVENTION

One of the fundamental design principles of the World Wide Web is interoperability. The World Wide Web Consortium (W3C) develops the Web's languages and protocols with the expressed goal of allowing software and hardware of different kinds to access the web. Still, most sites are designed for desktop computers with large color monitors.

Mobile wireless communication devices, such as mobile telephones, PDAs or palmtop computers typically have much smaller displays. There is obviously a need for providing a practical, intelligible, efficient and user-friendly solution for presenting Web pages with a general markup language content, such as HTML-(Hypertext Markup Language-) documents, on such mobile devices.

### RELATED BACKGROUND ART

The difficulties of displaying Web content effectively on a small mobile device such as a mobile telephone has contributed to the development of WAP (Wireless Application Protocol), which was intended to bridge the gap between the mobile world and the Internet. However, the use of the WAP technology requires that the applications are written in WML (Wireless Markup Language). Thus, only a limited amount of information and services is available via WAP.

From a number of prior art Web browsers it is known to use zooming in order to view pages written in e.g. HTML on a display. In this way, a small portion of the page may be enlarged to fill the display so that details of the page are shown. U.S. Patent Application Publication 2002/0030699 A1 discloses a mobile telephone which is provided with a small touch display. A Web page, retrieved from the Internet, is initially shown in its entirety on the display. When the user touches a particular area of the screen, this area is displayed in a magnified fashion by an “auto-zoom” feature. Zooming may be an appropriate way of getting the overview of complex web pages while also being able to magnify certain parts of the page. However, the content may be hardly legible when the page is zoomed out. In addition, when a text with in a fixed width format which is wider than the screen is to be displayed, horizontal scrolling will be necessary to make the information legible. Zooming is thus insufficient to provide an adequate presentation of Web pages on small display screens.

Handspring Blazer 2.0 is a prior art browser for use with palmtop communication devices. Using this browser, a HTML document may be adapted to the width of the display on a mobile client terminal and then presented on the display. However, the conversion is performed by a server in the network, not locally in the client terminal. Further, the Blazer 2.0 browser does not support the style sheet approach that is used in the present invention. Moreover, tests performed by the present applicant have shown that the Blazer solution apparently does not present the content of tables in a proper way, making horizontal scrolling necessary in order to make the content readable on a small display. The Blazer 2.0 also leaves a substantial amount of white space among the presented information, resulting in that more vertical scrolling is necessary.

### SUMMARY OF THE INVENTION

An object of the present invention is to provide a method, a device and a computer program which overcome the above-mentioned disadvantages of the prior art solutions.

A particular object of the invention is to provide a method, a device and a computer program which enables a HTML document, intended for presentation on a large desktop monitor, to be presented on a display on a client terminal with a small display, such as the display on a mobile telephone.

More specifically, an object of the present invention is to provide such a method, a device and a computer program which minimizes the need for scrolling by the user of the terminal.

Even more specifically, an object of the present invention is to provide such a method, a device and a computer program which eliminates the need for horizontal scrolling and which minimizes the need for vertical scrolling by the user of the terminal.

The above objects and further advantages are achieved by the features set forth in the appended set of claims.

According to the invention, content reformatting is provided to overcome the problem of presenting a HTML document on a small-sized display. Instead of presenting table content in columns and rows, tables are reformatted into a narrow, one-dimensional structure which is better fit for smaller displays. This is accomplished by converting tables into block-level elements.

The invention also provides additional advantageous features such as image blocking/reduction and transformation of space characters.

### BRIEF DESCRIPTION OF THE DRAWINGS

The invention will be described in greater detail, with reference to the drawings, in which

FIG. 1 is a block diagram illustrating a system wherein a mobile terminal is operating using a method according to the invention,

FIG. 2 is a flowchart illustrating an embodiment of the method according of the invention,

FIG. 3 shows an example of a Web page displayed on a large size screen and the corresponding reformatted page displayed on a small display on a mobile terminal.

### DETAILED DESCRIPTION OF THE INVENTION

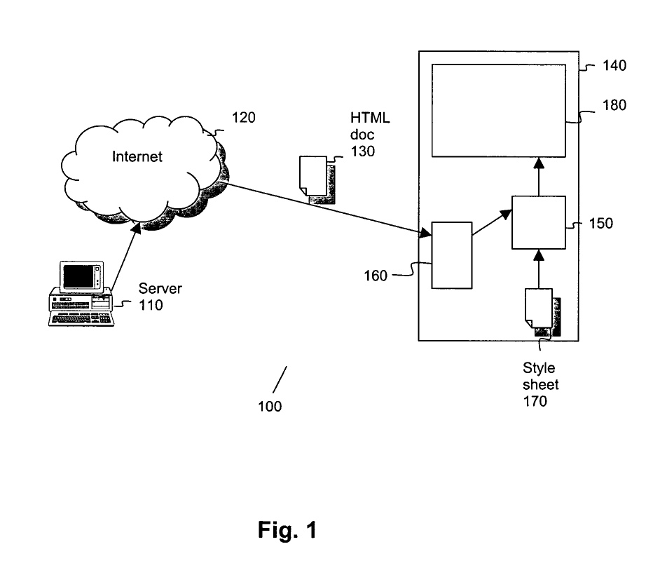

FIG. 1 is a block diagram illustrating a system 100 wherein a mobile client terminal 140, such as a mobile telephone, is operating using a method according to the invention.

A HTML document 130 is provided by a server 110 through the network 120 to the mobile client terminal 140. The mobile terminal 140 comprises a small sized display 180, which in the first place is not appropriate for presenting a general HTML content which was designed for a large display screen.

A small sized display may be defined in terms of the number of pixels present in the display, particularly the number of horizontal pixels in the display. As an example, a display with less than 300 pixels horizontally may be considered as a small sized display.

The HTML document 130 is retrieved by a wireless communication device 160, such as a GSM, GPRS, UMTS, CDMA or PCS module, and further transferred to a formatting device 150.

The HTML document 130 generally consists of three parts: content, structure and style. The content is the actual characters and images that are to be displayed. The structure describes the role of the content, for example that a certain string of characters is a headline. The style describes how to present the content, for example what fonts and color to use. The style is written in a style sheet or through presentational elements (e.g. FONT and CENTER in HTML).

According to the invention, when the mobile terminal 140 receives a HTML document via the communication device 160, it applies a browser style sheet 170 to the document, possibly overriding the document's own style in the process. By doing so, the mobile terminal enforces fonts, colors and other stylistic aspects to optimize rendering on the small display 180. The style sheet language preferably used is CSS (Cascading Style Sheets), with some extensions advantageously added, but it could in principle use any style sheet language to achieve this effect. Through this technique, the browser enforces a certain format, font size and possibly certain colors which are optimized for the display 180.

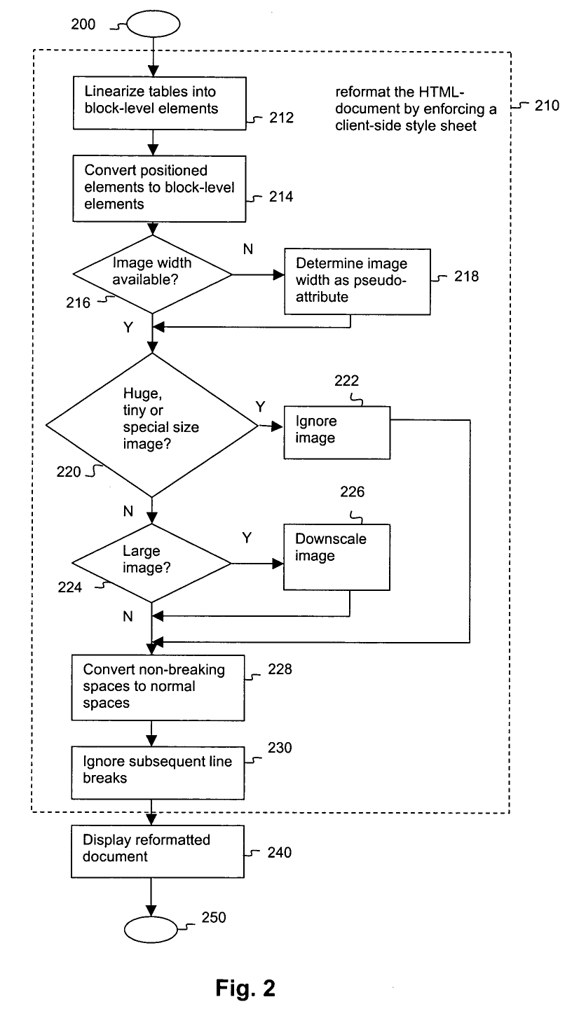

The formatting device 150 is controlled by a processing device and a memory. A software program is stored in the memory. The software program is arranged, when executed by the processing device, to perform the method according to the invention, as described in the following with particular reference to FIG. 2.

In an embodiment, the memory also includes an application program, and more exactly a browser program which supports style sheet interpretation. The interpretation of the style sheet by the browser program causes the processing device to perform the method according to the invention.

As a result, the HTML content is displayed in an intelligible, efficient and user-friendly way on the small-sized display 180.

FIG. 2 is a flowchart illustrating a method for presenting a HTML document on a small-sized display on a mobile client terminal, according to the present invention.

The method starts at reference 200, and comprises the initial step 210 of reformatting the HTML document by enforcing at least one client-side style sheet 170, thus adapting the width of the reformatted document to the width of the display, and the subsequent step 240 of presenting the reformatted document on the display.

The initial reformatting step is a process which comprises a number of substeps.

In the first substep 212, table cells in the HTML document are linearized to block-level elements. A block-level element is an element which has a line break before and after (like normal paragraphs have).

The HTML language is a simple declarative markup language where the tags describe the logical roles of the content (paragraphs, headings etc.) rather than how the content is presented (fonts, colors etc.). When tables were introduced in HTML 3.2 they were meant to represent simple rows and columns of number and text within documents—just like tables have been used in traditional documents. However, authors soon discovered that tables could be used (or abused) to wrap around documents and thereby achieve visual layouts. For example, the page could consist of a menu on the left side, an ad banner on the top, and a side bar on the right. This type of page layouts can be achieved with HTML table markup. Pages that use tables for layout purposes are often set to a fixed width, typically around 600 pixels. This width fits nicely on a desktop PC, but not on smaller web devices. Most often, the organization of the content into a table is purely a visual effect to achieve a grid type of layout.

According to the invention, the table is reorganized into block-level elements. All table cells in a row are combined to form a block-level element. I.e., each row is turned into a block-level element, and all block-level elements created from a table are presented on top of each other.

In the second substep 214, positioned elements in the HTML document are converted to block-level elements.

Usually, positioned elements are taken out of the text flow and displayed over other content. When converted according to the invention, positioned elements are turned into block-level elements and presented in the order they appear in the source document.

Images account for much of the data transfer on the web, and they usually take up significant screen area. Optimizing the handling of images is important for small screen web devices such as mobile terminals. According to the invention, images are selectively blocked and filtered to optimize performance.

According to the invention, images are handled differently based on their size:

“Huge images”, i.e. images much to big to fit the screen, are ignored and thus not downloaded/displayed.

“Tiny images”, i.e. very small images, typically play an ornamental role in table layouts. They may thus be ignored and not downloaded/displayed.

“Special sized images”, i.e. images with a special, predetermined format, often represents commercial advertisements, and may thus be ignored and not downloaded/displayed.

“Large images” (images that are slightly wider than the screen size) are downscaled to fit the screen size.

Other images are displayed normally.

The size of images is often specifically exposed in the HTML markup. Consider this example:

<IMG SRC=“foo.png” WIDTH=“20” HEIGHT=“30”>

In the above example, the image called “foo.png” has a size of 20 pixels horizontally and 30 pixels vertically. By exposing WIDTH/HEIGHT attributes in the markup, the browser is able to determine the size of the image before the image itself is downloaded. This way, the speed of document rendering can be improved.

Also, the browser can process the element based on the WIDTH/HEIGHT attributes. For example, using CSS, the style sheet can describe how to display element with certain attribute values:

IMG[WIDTH=“20”] {display: none}

The above style sheet expresses that IMG elements with a WITDH which has a value of “20” should not be displayed.

When the attributes are not present in the markup, this kind of processing is not possible. Consider this example:

<IMG SRC=“foo.png”>

It is not until the image is downloaded that the size can be established.

According to the invention, a feature is added which allows elements to be processed even if the attributes have not been specified in the markup. When the image is downloaded and the size has been determined, the width and height are exposed as pseudo-attributes which can be processed in similar ways as normal attributes. Consider this example:

IMG[$WIDTH=“20”] {display: none}

In the above example, the “$” sign indicates that the subsequent attribute name is a pseudo-attribute which does not appear in the markup, but which is exposed as if it had appeared in the markup.

The chief benefit of this particular feature is to allow style sheets to handle elements the same way when the author has included attributes as when the author has not included attributes.

Further in accordance with FIG. 2, in order to provide a measure of the size of an image, the width of an image pointed to in the HTML document is determined in the third substep 216. If the width is indicated as an attribute in the HTML document, this value is used for the width in the further substeps. If the width is not indicated, the width value is determined 218 as a pseudo-attribute, as described above.

In the fourth substep 220, the size of the image is considered in order to determine if the image should be ignored or included in the reformatted document.

This fourth substep 220 advantageously involves three conditions. If at least one of these conditions is met, the result of the substep 220 is that the image is ignored 222, and the process further continues at the sixth substep 228. If neither of the conditions is met, the process continues at the fifth substep 224.

The first condition in substep 220 is to determine if the image is regarded as “huge”. Preferably, this implies to test if the width of the image is larger than a first predetermined width limit, which is in the range 2 to 4 times the width of the display. Particularly preferred, the first limit is 3 times the width of the display. If the width of the image exceeds this limit size, the image is regarded as a huge image, and the image is ignored 222. The process then continues at the sixth substep 228.

Alternatively, an image will be regarded as a huge image if the height of the image exceeds a first predetermined height limit.

Alternatively, an image will be regarded as a huge image if both the height of the image exceeds the first predetermined height limit and the width of the image exceeds the first predetermined height limit.

As a further alternative, an image will be regarded as a huge image if another parameter associated with the size of the image exceeds a predetermined limit.

The second condition in substep 220 involves determining if the image is regarded as “tiny”. Very small images typically play an ornamental role in table layouts, such as borders, and they can usually be ignored without losing essential information. More specifically, this second condition implies to test if the width of the image is less than a second predetermined width limit, typically in the range 1 to 30 pixels, and particularly preferred 15 pixels, and also if the height of the image is less than a second, predetermined height limit, typically in the range 1 to 36 pixels, and particularly preferred 18 pixels. If the size of the image is within both these criteria, the image is regarded as a tiny image, and the image is ignored 222. The process then continues at the sixth substep 228.

The third condition in substep 220 involves determining if the image is regarded as a “special size image”. An image which exactly matches a certain predetermined set of width and height will likely be recognized as a commercial advertisement, and such images may usually be ignored without losing essential information. If both the width and height of the image matches predetermined values, the image is ignored 222. The process then continues at the sixth substep 228.

9 advantageous sets of corresponding width and height values for special size images are given in table 1 below: These values correspond to advertisement image dimensions as recommended by the Internet Architecture Board (IAB).

| set no. | width (pixels) | height (pixels) |
|---|---|---|
| 1 | 468 | 60 |
| 2 | 120 | 600 |
| 3 | 150 | 100 |
| 4 | 728 | 90 |
| 5 | 730 | 92 |
| 6 | 336 | 280 |
| 7 | 125 | 600 |
| 8 | 300 | 250 |
| 9 | 150 | 600 |

Table 1. Sets of Corresponding Widths and Heights for Special Size Images

In the fifth substep 224, the size of the image is considered in order to determine if the image should be regarded as a “large” image. A large image, contrary to a huge image, should be downscaled in the reformatted document, rather than being ignored. This is accomplished by comparing the width of the image with a third predetermined limit, which is in the range 0.5 to 3 times the width of the display. Preferably, the third predetermined limit is equal to the width of the display, which means that all images that are not regarded as tiny or huge, and which also exceeds the width of the display, are regarded as “large”. Images that in this way is regarded as large, are downscaled 226 to fit the display width, advantageously leaving room for a border on each side.

In the sixth substep 228 of the reformatting step 210, subsequent line breaks in the HTML document are ignored, thus reducing the vertical size of the reformatted document. Line breaks in HTML can be generated with the BR element, and it is common to add subsequent BR elements to push other elements apart vertically. This may look nice on a desktop screen, but valuable vertical space can be saved by ignoring subsequent line breaks according to this feature of the invention.

In the seventh substep 230 of the reformatting step 210, non-breaking space characters in the HTML document are converted into normal space characters, thus reducing the horizontal size of the reformatted document. Non-breaking space characters (denoted “nbsp;” in HTML) are used to denote a space between strings that is unfit for a line break. On a small screen, however, the browser is more often forced to break lines, and the non-breaking space character cannot be honored.

In addition, as a part of the seventh substep 230, additional empty spaces may advantageously also be ignored.

When the seventh substep 230 and thus the formatting step 210 is completed, the reformatted document is displayed on the mobile client terminal (step 240).

The method according to the invention advantageously provides the additional feature of applying a fixed font type and a fixed font size for all the text in the HTML document, particularly a font type and size which is especially clear and intelligible when displayed on the small-sized display 180.

The method according to the invention advantageously provides the additional feature of centering the images to be displayed on the small-sized display 180.

The method according to the invention may advantageously provide the additional feature of zooming a page in and out.

For a person skilled in the art, it will be an ordinary task, based on the presented disclosure of the invention, to implement the method according to the invention as a computer program. Such a computer program comprises instructions which, when executed by a processing device in the mobile client terminal, performs the method according to the invention.

Particularly, the computer program may be embodied on a computer readable medium, such as a magnetic disk or a CD-ROM. Alternatively, it may be contained in a memory, such as a read-only memory or a volatile memory, or it may be embodied on a propagated signal, e.g. during transfer between computers or network elements in a digital communication network, such as the Internet.

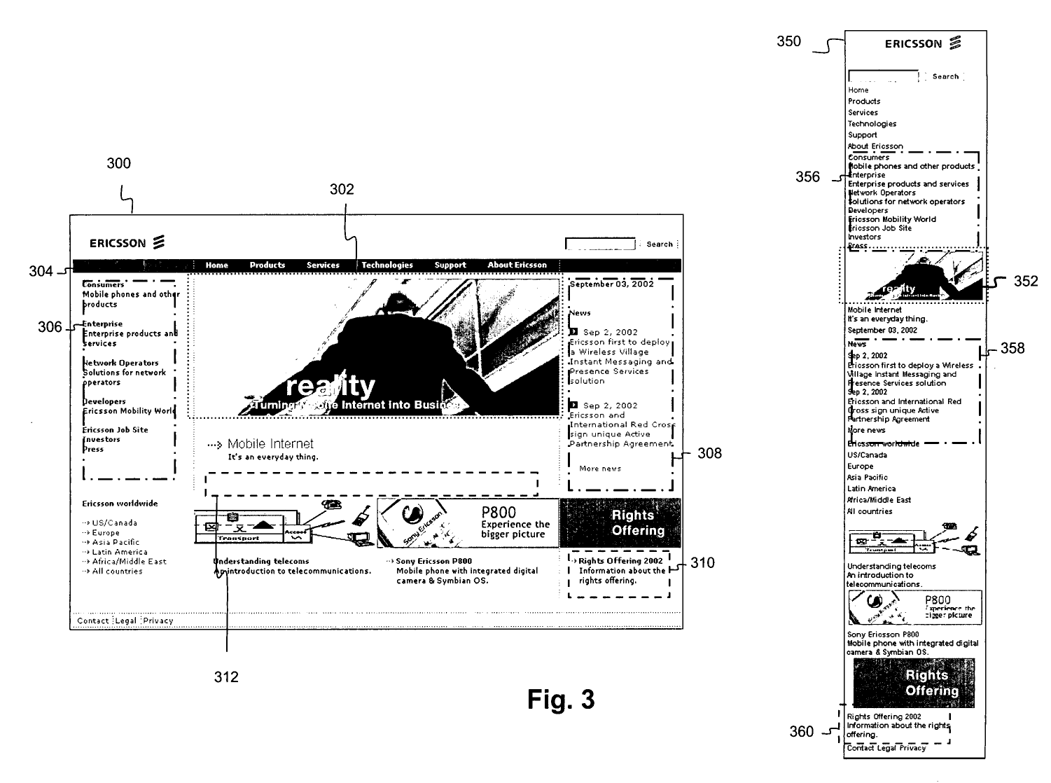

FIG. 3 shows a simplified example of a Web page 300 displayed on a large size screen and the corresponding reformatted page 350 displayed on a small display on a mobile terminal, according to the invention. The original page 300 will be represented by an original HTML document, and the reformatted page 350 will be represented by the reformatted document resulting by the method according to the invention.

The width of the reformatted page 350 is adapted to fit the width of the small display on the mobile terminal. Although not shown in the figure, it will be understood that the height of the reformatted page significantly exceeds the height of the display. Vertical scrolling is thus necessary, while horizontal scrolling is unnecessary.

Assume now that the method according to the preferred embodiment of the invention, as illustrated in FIG. 2, is applied to the page 350. The following description will illustrate a particular example of use of the invention.

It should be understood that only some of the elements in the original page 300 is mentioned in this simplified description, which is disclosed by example in order to explain the principles of the invention.

In the first substep 212, the tables 206, 308 will be linearized into block-level elements 356, 358. As can be seen in the reformatted page 350, this results in a compact, legible layout.

Positioned elements present in the original HTML document, such as the text and link portion 310, will be converted to a block-level element and displayed as indicated by 360. Additionally, particular fonts and link styles in the text and link portion 310 will be changed to a simple, uniform font and style.

Assume also that size parameters for the image 302 is available in the original HTML document. The third substep 216 will then continue to the fourth substep 220.

The size of the image 302 does not meet any of the “huge”, “tiny” or “special size” conditions, and thus, the method continues at the fifth substep 224.

In the fifth substep 224, the image 302 is recognized as a large image. The image will thus be downscaled to substantially the width of the display, as shown at 352 in the reformatted page in FIG. 3.

The image 304, which actually is an ornamental image element with no substantial information content, is recognized as a tiny image in the fourth substep 216. Consequently, the image 304 is ignored, and is not displayed in the reformatted page 350.

The white space 312 is recognized as containing no relevant information, and is thus also ignored in the reformatted page 350.

The resulting, reformatted page 350 has a compact, legible layout which makes horizontal scrolling unnecessary, and which minimizes the need for vertical scrolling. The invention thus involves the technical benefit of enabling standard WWW content to be efficiently displayed on a terminal which may be significantly reduced in size. While the functional properties of the original WWW page, such as hyperlinks, is maintained in the reformatted page, the format of the original WWW document is considerably compacted.

It will of course be understood that the invention is not limited to the specific details described above, which are given by way of example only.

For instance, FIG. 2 illustrates a particular embodiment of the method according to the invention. It will be obvious that all the details in the illustrated steps and substeps are not crucial to achieve the purpose of the invention.

The skilled person will further realize that the various steps and substeps not necessarily need to be performed in the illustrated order. Dependent on the particular implementation, some substeps may be interchanged, and some may even be performed concurrently.

The first substep 212 of linearizing tables into block-level elements is the most essential subfeature of the reformatting step 210. However, if other substeps are included, the first substep 212 does not need to be the first substep to be performed in the reformatting step.

Likewise, the second substep 214 of converting positioned elements may as well be performed at other stages in the process, e.g. at the last stage just before the display step 240.

As another example of an obvious modification, each of the sixth substep 228 of ignoring line breaks and the seventh substep 230 of converting non-breaking spaces may readily be performed at an earlier stage, such as subsequent to the second substep 214 of converting positioned elements.

The image blocking and filtering substeps 216, 220 and 224 may likewise be freely rearranged or modified in the skilled person's option.

Although the invention is particularly relevant for application with mobile telephones and handheld communication devices such as PDAs, the skilled person will of course realize that numerous other applications also exist, such as display terminals for use in automobiles, aircrafts and vessels.

It is thus evident to the person skilled in the art that various modifications and alterations are possible within the scope of the invention, as set forth in the appended set of claims.

1. Method for presenting a HTML document (130) on a display (180) on a small screen client terminal (140), comprising the steps of
reformatting (210) the HTML document by enforcing at least one client-side style sheet (170), thus adapting the width of the reformatted document to the width of the display (180), and
presenting (240) the reformatted document on the display (180).

2. Method according to claim 1, wherein the step (210) of reformatting the HTML document includes
converting (212) table cells in the HTML document to block-level elements.

3. Method according to claim 2, wherein the step (210) of reformatting the HTML document includes
ignoring (220, 222) images whose width exceeds a first predetermined size, thus omitting images which are huge compared to the size of the display.

4. Method according to claim 2 or 3, wherein the step (210) of reformatting the HTML document includes
ignoring (220, 222) images whose size is less than a second predetermined size, thus omitting images which likely represent ornamental graphics.

5. Method according to one of the claims 2-4, wherein the step (210) of reformatting the HTML document includes
ignoring (220, 222) images whose width and height equals one of a predetermined set of widths and heights, thus omitting images which likely represent commercial advertisements.

6. Method according to one of the claims 2-5, wherein the step (210) of reformatting the HTML document includes
downscaling (224, 226) images whose size exceeds a third predetermined size, thus reducing images which are large compared to the size of the display.

7. Method according to one of the claims 3-6, wherein the size of the image is determined (216, 218) as a pseudo-attribute if a parameter of the size is not present as an attribute in the HTML document.

8. Method according to one of the claims 2-7, wherein the step (210) of reformatting the HTML document further includes
converting (214) positioned elements in the HTML document to block-level elements.

9. Method according to one of the claims 2-8, wherein the step (210) of reformatting the HTML document further includes
ignoring (228) subsequent line breaks, thus reducing the vertical size of the reformatted document.

10. Method according to one of the claims 2-9, wherein the step (210) of reformatting the HTML document further includes
converting (230) non-breaking space characters into normal space characters, thus reducing the horizontal size of the reformatted document.

11. Method according to one of the preceding claims, further comprising the feature of zooming a page in and out.

12. Client terminal (140) arranged to present a HTML content on a small sized display (180), comprising
a communication device (160) and
a formatting device (150), said formatting device including a processing device and a memory device,
wherein the formatting device (150) is arranged to perform a method according to one of the claims 1-11 in order to present the HTML content on the small sized display (180).

13. Computer program, comprising instructions which, when interpreted by an application program executed by a processing device, performs a method according to one of the claims 1-11.

14. Computer program according to claim 13, wherein the instructions are style sheet instructions, and wherein the application program is a browser program which supports style sheet interpretation.

15. Computer program according to claim 14, embodied as a client-side style sheet.

16. Computer program according to claim 14, further comprising the browser program.

17. Computer program according to one of the claims 13-16, embodied on a computer readable medium, or in a memory, or on a propagated signal.
